(19) United States
(12) Patent Application Publication
(10) Pub. No.: US 2020/0109744 A1
(43) Pub. Date: Apr. 9, 2020

(54) THREE-MATERIAL ROLL-BONDED SLIDING BEARING HAVING TWO ALUMINIUM LAYERS

(71) Applicant: FEDERAL-MOGUL WIESBADEN GMBH, WIESBADEN (DE)

(72) Inventors: GAETANO FABIO COSENTINO, WIESBADEN (DE); MICHAEL WAGNER, WIESBADEN (DE); TOBIAS SEIDLING, WIESBADEN (DE)

(21) Appl. No.: 16/497,545

(22) PCT Filed: Mar. 23, 2018
(86) PCT No.: PCT/EP2018/057427

§ 371 Date: Sep. 25, 2019

(30) Foreign Application Priority Data
Mar. 29, 2017 (DE) 10 2017 205 338.0

(51) Int. Cl. F16C 33/12; C22C 21/14; C22C 21/18; C22C 21/16

(52) U.S. Cl. CPC F16C 33/121; F16C 33/127; C22C 21/14; C22C 21/18; F16C 2223/32; F16C 2202/06; F16C 2240/60; F16C 2204/20; C22C 21/16

(57) ABSTRACT

A sliding bearing element has a steel supporting layer onto which a 2-layer composite is applied which consists of an aluminum-based substrate having a layer thickness hs of 0.2 to 0.4 mm and an aluminum-based sliding layer having a layer thickness hG of 0.005 to 0.1 mm. The substrate and the sliding layer are joined by roll bonding. A sliding bearing is made from two sliding bearing elements of this kind, which are predominately used for applications in high-performance engines, principally for connecting-rod bearings, crankshaft main bearings and connecting rod bushes, but also in applications in mounting camshafts and counterbalance shafts as well as transmissions.

The present invention relates to a sliding bearing element, in particular a sliding bearing shell, having a steel supporting layer onto which a 2-layer composite is applied, which comprises an aluminum-based substrate layer and an aluminum-based sliding layer, and to a sliding bearing made from two such sliding bearing elements, which are predominantly used for applications in high-performance engines, principally for connecting rod bearings, crankshaft main bearings and connecting rod bushes, but also in applications in mounting camshafts and counterbalance shafts as well as transmissions.

The aluminum-based bearing metal materials are usually cast as a solid aluminum strip and, after forming and heat treatment steps, are joined to a steel strip by bonding, usually roll bonding. Compared to copper-based bearing metals, aluminum-based bearing metals provide better embedding properties, which means the ability of the material to absorb and embed foreign particles in the bearing gap, for example through abrasion or contamination. The sliding or at least the emergency running properties of the aluminum bearing metals are also regularly better, especially if they have a higher tin content. These materials can therefore be used with or without a sliding layer. In the first case, this is referred to here as a two-material system or bearing, in the second case, as a three-material system or bearing.

As is generally known, the two-layer and three-layer systems may also have a thin intermediate layer to improve adhesion between the steel back and the bearing metal layer. Together with the intermediate layer, the bearing metal layer is then regularly pre-bonded to form a composite, first by roll-bonding, and then the composite is also joined to a steel strip by roll-bonding.

As a rule, the intermediate layer in the composite has no function other than that of an adhesion promoter, is often a pure aluminum layer and is therefore not included in the categorisation into two-layer and three-layer systems.

Two-layer and three-layer systems are also known, which have a polymer coating (anti-friction coating) as a running-in layer. According to this, even such non-metallic layers are not included in the categorisation into two-layer and three-layer systems.

Sliding bearing elements made of an aluminum two-material system are disclosed, for example, in DE 102 46 848 A1, DE 103 43 618 B3, DE 10 2005 023 541 A1, DE 10 2009 002 700 B3, DE 10 2011 003 797, DE 10 2011 087 880 B3 and EP 1 522 750 B9. The publications discuss aluminum-based bearing metals, the wear resistance, heat and fatigue strength of which is to be improved by adding in each case a plurality of a number of elements selected from Sn, Pb, In, Bi, Si, Zn, Cu, Mg, Mn, Ni, Ti, Co, V and/or Cr.

The term “strength” is generally used to describe the mechanical resistance of a material to separation or plastic deformation. The strength of a material quite substantially depends on the structure of the crystal lattice, including displacements. Different types of strengths are indicated depending on the type and manner of stress. The so-called “fatigue resistance” or “fatigue strength” is a dynamic strength, which describes the mechanical resistance of a material to stresses that change over time.

The “tensile strength” is usually determined in a comparatively simple tensile test, from which conclusions can then be drawn about the fatigue resistance or fatigue strength.

The term “wear resistance” refers to the resistance of a material to mechanical abrasion. In turn, wear can have different causes. On the one hand, there is the seizing wear, in which two materials literally bond together under the frictional heat, which leads to the removal of one of the materials. On the one hand, there is the seizing wear, in which two materials are literally welded together under the friction heat, which leads to the removal of one of the materials. On the other hand, wear or abrasion occurs due to different hardness of the friction partners. A measure for the wear resistance is therefore the hardness of the material, which is understood as the resistance which a material puts up against the mechanical penetration of another body and which can also be determined relatively easily in one of the numerous known hardness tests.

With regard to the alloying components mentioned above, a general distinction can therefore be made between two effects. The so-called soft phases, such as Pb, Sn or Bi, reduce seizing and wear as solid lubricants, if possible even under mixed friction conditions. The hard or solidifying components, such as Si or intermetallic phases of Al with Mn, Cu, Mn, Zn have, depending on their size and distribution, a strength-increasing effect and also contribute to the reduction of wear due to their hardness.

DE 10 2009 002 700 B3 also deals with an aluminum copper alloy as an intermediate layer, the thickness and hardness of which are adapted to the properties of the bearing metal layer in order to achieve overall sufficient plastic flexibility and form adaptability of the sliding bearing shell.

The general disadvantage of two-layer systems is that the effects of the soft phases on the one hand and the strengthening components on the other are partially opposed in one layer. The bearing metals used here therefore always represent a compromise with regard to the properties of wear resistance and/or thermal and fatigue strength.

Known sliding bearing elements made of a three-material aluminum system as disclosed, for example, in WO 2016/023790, have a steel back as a supporting layer, at least one bearing metal layer and a sliding layer applied to the bearing metal layer by means of electroplating or sputtering. This makes it possible to optimise the aluminum alloy of the bearing metal layer, for example for demanding use in combustion engines, with regard to its strength and at the expense of embedding capability and wear resistance. The latter properties are taken over by the sliding layer, which has been optimised accordingly. The bearing metal layer must then at most have emergency running properties.

For the sliding layer, thin metal layers applied chemically or electrochemically (galvanically) or by means of a PVD process, in particular sputtering, can be considered (cf. DE 10 2005 063 324 B4 or DE 10 2005 063 325 B4), in which case a tin-containing aluminum alloy is applied as a sputter layer to a substrate made of a copper alloy. Such sliding layers are very thin due to the manufacturing process, which is basically an advantage, because they do not have a high strength. The fatigue strength of the entire bearing is determined all the more by the strength of the underlying bearing metal or substrate layer, the thinner the sliding layer.

The above-mentioned coatings are applied to the finished sliding bearing during the manufacture of sliding bearings. The application of the sliding layer therefore makes the manufacture of these sliding bearings considerably more expensive.

In many cases, an intermediate or barrier layer is also provided between the bearing metal layer and the sliding layer as a diffusion barrier, which is also usually galvanically deposited and makes the manufacturing process even more expensive.

The object of the present invention is therefore to provide a bearing element, in particular a sliding bearing shell, which is as inexpensive to manufacture as a two-material bearing and which, if possible, has the wear resistance and embedding capability and at the same time the heat and fatigue strength of a three-material bearing.

The object is achieved by a sliding bearing element according to claim 1, comprising a steel supporting layer onto which a 2-layer composite is applied, which comprises an aluminum-based substrate layer having a layer thickness of 0.2 to 0.4 mm and an aluminum-based sliding layer having a layer thickness of 0.005 to 0.1 mm, wherein the substrate layer and the sliding layer are joined by roll-bonding and are lead-free.

The sliding bearing element according to the invention is based on the fact that, unlike with the two-layer bearings mentioned above, there is no mediation between wear resistance and fatigue strength within one layer, but that, as with the known three-layer bearings, these two material properties are each assigned to a separate layer. Thus, while the substrate layer in the sliding bearing element according to the invention is adjusted in such a way that it ensures a high fatigue strength, the sliding layer has very good wear resistance with optimised embedding capability.

In contrast to the known three-material systems, the sliding layer and the bearing metal layer are joined by roll-bonding.

This facilitates the manufacturing process considerably. In particular, a two-component composite made of the sliding layer and the bearing metal layer material can be prefabricated as a strip before it is applied to the steel supporting layer. By joining the individual layers by roll-bonding, continuous strip production is possible without costly coating of the individual, already formed sliding bearings. This simplifies the manufacture of the sliding bearings and reduces costs.

Since process-safe roll-bonding generally requires a higher material thickness than the desired sliding layer thickness of 0.005-0.1 mm, machining may be necessary after the application of the sliding layer, in contrast to galvanic deposition or sputtering, for example. In the case of flat sliding bearing elements, this can be done very efficiently on the strip, which does not significantly increase production costs. In the case of radial bearing elements, such as bearing shells or bushes, the post-processing is carried out on the formed workpiece by drilling/profile drilling or broaching. This process is always necessary and also takes place with the known three-material bearings, which is why there are no additional costs in this respect. There, however, the bearing metal layer is machined before coating with the sliding layer material. Interestingly, when profile drilling eccentric profiles, machining ensures that the sliding layer has a varying wall thickness, while the substrate layer has a constant thickness. In the case of the known radial bearings, the opposite is true. The sliding layer thickness of 0.005-0.1 mm given here refers to the thinnest point of the sliding layer for such bearings with varying wall thicknesses, whereby the difference in profile thickness can be up to 25 μm. In other places the thickness can therefore also exceed 0.1 mm.

In an advantageous embodiment, the substrate layer of the sliding bearing element comprises a first aluminum alloy which, in addition to unavoidable impurities, comprises one or more of the components
0.1-8.0 wt. % copper,
0.1-2.0 wt. % manganese,
0.2-5 wt. % nickel,
1.0-8.0 wt. % zinc,
0.1-5.0 wt. % magnesium,
0.1-2.0 wt. % silicon,
0.05-1.0 wt. % chromium,
0.05-1.0 wt. % vanadium, and the rest

aluminum.

In the sliding bearing element according to the invention, the substrate layer ensures a high fatigue strength, in a manner known per se, by the fact that one or more of the elements Cu, Mn, Ni, Zn, Mg and Si are optionally alloyed as strength-increasing elements.

In an advantageous embodiment, the first aluminum alloy in combination comprises
0.4-6.0 wt. % copper and
0.3-2.0 wt. % manganese.

Copper forms intermetallic precipitates or phases with aluminum, which block dislocations in the crystal lattice and thus increase the strength of the material without reducing the bond strength of the substrate layer to the steel back. It has been shown that with a copper content of 0.4-6.0 wt. % and corresponding annealing treatment, the coherent precipitates essential for the strength are formed optimally with regard to size, shape and distribution.

Manganese also forms intermetallic precipitates or phases with aluminum, which lead to an increase in the viscosity of the aluminum alloy and a reduction in the susceptibility to intergranular cracking. It also serves as a dispersion forming agent. Preferably, the manganese content is 0.3-2.0 wt. %, where the manganese inhibits recrystallisation and is therefore mainly responsible for the significantly improved thermal stability or heat resistance. Even in the presence of copper, the coating is therefore less sensitive to temperature influences, as is the case in particular in the operation of modern combustion engines. In addition, an increased recrystallisation temperature in the manufacturing process favours the size and shape of precipitates in general. An excessively high proportion of Mn, on the other hand, promotes the formation of so-called incoherent precipitates in the form of brittle Al₆Mn crystals, which have a negative effect on the strength of the material.

Preferably, the first aluminum alloy also contains 0.5-3 wt. % nickel and 0.05-1.0 wt. % vanadium or 0.2-2.5 wt. % magnesium and 0.1-2.0 wt. % silicon.

In the one case, the nickel produces additional mixed crystal solidification in the specified range by occupying lattice locations in the crystal. Here the copper content can be selected to be lower.

In the other case, the magnesium leads to better cold curing through coherent precipitates, with in particular the Cu/Mg ratio playing an important role.

In addition, the two embodiment variants of the invention have proved to be preferable because, with suitable thermal treatment, they have a very good bond strength to the steel supporting layer and therefore also serve as good adhesion promoters to the sliding layer.

Preferably, the sliding layer is made of a second aluminum alloy which, in addition to unavoidable impurities, comprises one or more of the components
1.0-10.0 wt. % silicon,
5.0-30.0 wt. % tin,
0.1-5.0 wt. % copper,
0.1-3.0 wt. % manganese,
0.05-1.0 wt. % vanadium,
0.05-1.0 wt. % chromium, and the rest

aluminum.

Preferably, the second aluminum alloy in combination comprises
1.0-6.0 wt. % silicon,
5.0-25.0 wt. % tin and
0.3-2.5 wt. % copper.

As already mentioned above, the sliding layer takes over above all the functions of very good wear resistance and embedding ability. First of all, the tin content in the aluminum alloy, stated as 5.0-30.0 wt. %, is responsible for this, which, compared to the aluminum alloys of the two-layer systems, is high and therefore significantly increases the embedding ability and the dry running capacity of the sliding layer. 5 wt. % is at least necessary for this, but preferably at least 10 wt. %. Only when the upper limit of 30 wt. % is exceeded does the strength of the sliding layer decrease to such an extent that the layer can no longer withstand high stress, when considered in isolation.

A higher level of safety can be achieved if the upper limit value of 25 wt. % is adhered to; 21.5 wt. % is particularly preferred as the upper limit. The high tin content benefits sliding bearing elements, which occasionally operate under mixed friction conditions, such as bearings in combustion engines with start/stop operation, i.e. bearings on which hydrodynamic oil lubrication is not ensured in certain phases. In addition, the alloy can be machined more easily as a result of the tin, which can increase the accuracy, for example during drilling, in the post-processing of the sliding bearing element. In addition, the service life of the tools used for reworking is increased. At the same time, by adjusting the sliding layer in the composition of the substrate layer, those alloying elements which increase the wear resistance and reduce the fatigue strength can be dispensed with.

As shown for the substrate layer, copper increases the strength of the alloy due to the formation of intermetallic precipitates, so that the sliding layer also contributes to a limited extent to the increase in load-bearing capacity.

By offering Si-particles and their size and distribution controlled by heat treatment, the tendency to seizing can be reduced or the wear resistance can be considerably improved by precipitation hardening, which is again advantageous under mixed friction conditions, but also in “normal” hydrodynamic operation.

Silicon is preferably distributed in such a way that 35-70 Si particles >5 μm can be found on an area of 0.04 mm².

Particularly preferably, the maximum particle size is 35 μm.

This particle size distribution has turned out to be particularly advantageous because the Si hard particles >5 μm are sufficiently large to ensure a high wear resistance of the material as hard supporting crystals.

To determine the particle size distribution, a surface cutout of the bearing metal layer of a specific dimension is examined under a microscope, preferably at 500 times magnification. The sliding layer can be viewed in any plane, since it is assumed that the distribution of the Si particles in the layer is substantially homogeneous, or at least that a distribution that is intentionally or unintentionally inhomogeneous, i.e. gradually increases or decreases in one direction for example, in any case does not leave the claimed limits. For this purpose, the sliding layer is preferably prepared in such a way that a flat cut is made first. The Si-particles visible in the surface cutout are measured in such a way that their longest recognisable expansion is determined and equated with the diameter. Finally, all the Si particles in the surface cutout with a diameter >5 μm are added up and the number of said particles in the total measuring surface examined is related to a standard surface. The diameters of all the Si particles falling into such a class (>5 μm) can also be determined and added up and an average value can be calculated from them.

Preferably, the second aluminum alloy also comprises 0.1-1.5 wt. % manganese or 0.05-1.0 wt. % vanadium and 0.05-1.0 wt. % chromium.

In one case, the manganese, as in the substrate layer so in the sliding layer, serves to increase the viscosity, reduce the susceptibility to intergranular cracking and acts as a dispersing agent as well as an inhibitor of recrystallisation and is therefore mainly responsible for improved thermal stability or heat resistance.

In the other case, the chromium takes over this function in parts. The chromium content is matched to the copper content in the aluminum matrix and is responsible for the heat resistance of the material, which is always also required for the sliding layer in highly stressed applications. The chromium content of 0.0 to 1.0 wt. % with a simultaneous addition of 0.3 to 2.5 wt. % copper has proved to be advantageous in order to form sufficiently strength-increasing precipitates in the sliding layer matrix. On the other hand, a content of 1.0 wt. % should not be exceeded in order not to negatively influence the formability.

Finally, the latter aluminum alloy of the bearing metal layer comprises 0.05 to 1.0% wt. % vanadium, which in this case inhibits the recrystallisation of the matrix material, because it raises the recrystallisation temperature thereof. As a result, vanadium also serves to increase the heat resistance.

In an advantageous embodiment, the substrate layer of the sliding bearing element has a Brinell hardness of 50-100 HBW 1/5/30 and/or a tensile strength of 200-300 MPa in the finished state.

In another advantageous embodiment of the sliding bearing element, the sliding layer has a Brinell hardness of 25-60 HBW 1/5/30 and/or a tensile strength of 100-200 MPa in the finished state.

As described at the outset, one can conclude from the tensile strength the fatigue or fatigue strength of the material. Hardness is also an indicator of wear resistance. Hardness and tensile strength can also be used to draw conclusions about the machinability of the material.

It has now been shown that with the specified hardness and tensile strengths, the material properties of the sliding and substrate layers are adjusted in such a way that the bearing element shows no significant or at least fewer failures than the known two-material bearings, even under the highest thermal loads, highest load peaks and temporary deficient lubrication. If the hardness of the substrate layer falls below the lower limit value, the risk of plastic deformation of the material increases too much, which affects the permanent load-bearing capacity of the entire bearing and leads to a failure in the long term. If it exceeds the upper limit value, the material becomes brittle.

The same applies to the sliding layer: If the hardness of the sliding layer falls below the specified lower limit value, this layer can also plastically deform, which does not immediately lead to a failure, but shortens the service life of the sliding layer in an unacceptable way. If it exceeds the upper limit value, this is accompanied by a marked decrease in embedding ability.

The invention further relates to a sliding bearing shell as a design of the sliding bearing element described above and, in particular, to a sliding bearing shell having a nominal diameter of <100 mm, preferably <80 mm.

“Nominal diameter” means the inner diameter of a sliding bearing composed of two sliding bearing shells, at least one of which has been designed in accordance with the invention. Such sliding bearings are preferably considered as crankshaft main bearings or connecting rod bearings in an internal combustion engine. As a rule, in this case there is a bearing side with a higher load and a bearing side with a lower load.

The design of the sliding bearing according to the invention makes it possible to combine two different sliding bearing shells within such a bearing location in such a way that the sliding bearing shell subjected to higher loads has the thin sliding layer according to the invention, while the counter shell of the same sliding bearing subjected to fewer loads has a thicker sliding layer with the same overall bearing thickness. In principle, the thinner sliding layer is advantageous where high fatigue strength is required, while the thicker sliding layer has better embedding behaviour in order to reduce the dirt sensitivity of the entire sliding bearing. In this way, the respective properties of the sliding bearing shells can be tailored even more precisely to the specific application situation.

The sliding bearing element according to the invention will be explained in greater detail with reference to the drawings and examples. In the drawing:

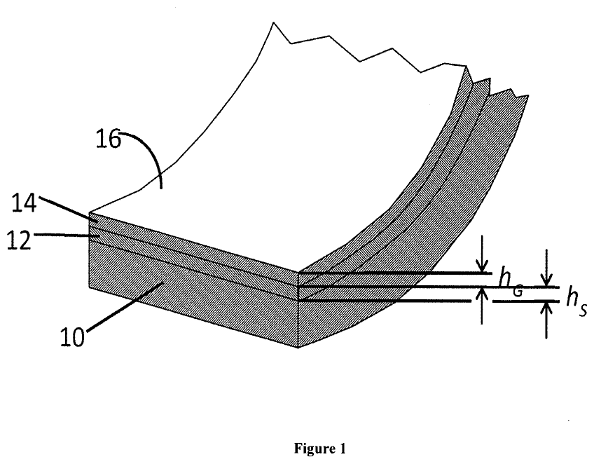

FIG. 1 shows a basic layer structure of the sliding bearing element according to the invention.

FIG. 1 is a perspective sectional view of a sliding bearing element in the form of a sliding bearing shell according to the invention. The sliding bearing shell has a total of three layers. The lowest layer is a supporting or carrier layer 10 made of steel. A substrate layer 12 is applied to the carrier layer 10. A sliding layer 14 is in turn arranged on the substrate layer 12. The substrate layer 12 and the sliding layer 14 each have the aluminum-based composition discussed above. The sliding layer has a thickness hG of 0.005 to 0.1 mm. The following applies: The thinner the sliding layer, the higher the contribution of the thicker substrate layer to the fatigue strength. The substrate layer has a thickness hs of 0.2 to 0.4 mm.

Table 1 below shows two embodiments of the aluminum alloy of the substrate layer and Table 2 shows two embodiments of the aluminum alloy of the sliding layer.

TABLE 1
Sample composition substrate layer (proportions in wt. %)

| | Al | Cu | Mn | Ni | Mg | Zn | Cr | Si | V |
|---|---|---|---|---|---|---|---|---|---|
| S1 | REST | 0.6 | 0.6 | 1.5 | — | — | — | — | 0.2 |
| S2 | REST | 4.5 | 0.7 | — | 0.7 | — | — | 0.5 | — |

TABLE 2
Sample composition sliding layer (proportions in wt. %)

| | Al | Sn | Cu | Si | Cr | V | Mn |
|---|---|---|---|---|---|---|---|
| G1 | REST | 21.5 | 1.0 | 4.0 | — | — | 0.35 |
| G2 | REST | 10.0 | 0.8 | 2.4 | 0.2 | 0.2 | — |

The tensile strengths and hardness of the embodiments listed above are shown in Table 3 below.

TABLE 3
Hardness and tensile strengths Rₘ of substrate
layers (S1 and S2) and sliding layers
(G1 and G2) at different points in the manufacturing process

| | Before | | Before | | Before | | Finished | |
|---|---|---|---|---|---|---|---|---|
| | roll-bonding | | roll-bonding | | final | | bearing | |
| | on aluminum | | on steel | | annealing | | shell | |
| | | Hard- | | Hard- | | Hard- | | Hard- |
| | Rₘ | ness | Rₘ | ness | Rₘ | ness | Rₘ | ness |
| | [MPa] | [HBW] | [MPa] | [HBW] | [MPa] | [HBW] | [MPa] | [HBW] |
| S1 | 238 | 71 | 166 | 45 | 265 | 75 | 250 | 70 |
| S2 | 190 | 51 | 180 | 48 | 240 | 63 | 225 | 60 |
| G1 | 181 | 55 | 130 | 35 | 175 | 57 | 130 | 38 |
| G2 | 193 | 56 | 146 | 44 | 190 | 59 | 150 | 42 |

The hardness and tensile strengths were determined in accordance with DIN specifications EN ISO 6506 and DIN EN 10002.

In the following, the production of the bearing elements according to the invention and in particular the adjustment of the material properties of the aluminum alloys of the substrate layer and the sliding layer are described.

Through individual fine tuning of the composition and the process sequences during the production of the individual layers, the focus of the properties between load-bearing capacity, fatigue strength and/or sliding properties is set in the above parameter range depending on the requirement profile of the planned application.

A strip material made of a first aluminum alloy, which forms the substrate layer in the later composite material, and a strip material made of a second aluminum alloy, which forms the sliding layer in the later composite material, are provided. As can be seen from Table 3, these materials may initially have similar properties in terms of hardness and tensile strength. The casting of the strip materials is followed by annealing at a temperature between 400 and 550° C. for homogenisation. The precipitates of the easily soluble elements in the alloys, such as copper, magnesium, silicon or zinc, dissolve and are distributed evenly. All in all, the material properties are homogenised in this way. Precipitates of less soluble elements such as manganese increase become coarser and lose their angular shape (moulding). The strip materials can, for example, be cast on site and then rolled in alternating annealing and forming steps (rolls) to a desired thickness, for example 1.4 to 2 mm in each case, to form strips.

The two strip materials are then joined by cold roll bonding. The thickness of the joined layers after this first roll bonding is about 0.7 to 1 mm, which corresponds to a degree of deformation of about 50%. This is followed by one or more annealing treatments for recrystallisation at a temperature between 200 and 400° C. for 8 to 15 hours. This breaks down the internal energy of the dislocations created by the deformation by rearrangement and formation of a new grain structure, with recrystallisation starting at lower temperatures, the greater the cold deformation and the longer the annealing time. In addition, this leads to an overall decrease in tensile strength and hardness of the individual layers (cf. Table 3). The fine-grained and ideally completely recrystallised microstructure has the best forming properties.

The two-layer composite thus produced is then also applied to a steel strip by cold roll bonding, i.e. joined to form a three-layer composite, with the substrate layer arranged on top of the steel layer. This is followed, if necessary, by further rolling steps in which the thickness of the substrate layer and the sliding layer is further reduced to the desired final dimension (the substrate layer). Here, degrees of deformation of at least 50% are achieved, whereby high degrees of deformation are accompanied by a better bond between the two-layer composite and the steel back. The substrate thickness and the sliding layer thickness then each amount to about 0.2 to 0.4 mm.

After roll bonding and individual further rolling steps, recrystallisation annealing can follow again, if required. At the end of the deformation process, whether after roll bonding to the steel strip or after the further rolling pass(es), a final annealing is performed at temperatures between 150 and 450° C., preferably between 200 and 350° C. for 4 to 12 hours, during which a bonding zone between the steel strip and the substrate material is formed by diffusion, which leads to an improvement in the bond between the layers.

In addition, the final annealing serves to adjust the material properties required above with regard to hardness and tensile strength. Due to the different chemical composition, the final annealing temperature can be selected above or below the recrystallisation threshold of one of the two layers, so that recrystallisation optionally takes place in the corresponding layer at the same time. Preferably the temperature is selected so that the substrate layer will survive the final annealing without significant tensile strength and hardness losses, while the sliding layer loses hardness.

Finally, the bearing element is formed from the 3-layer composite material by, for example, cutting off blanks, forming them into sliding bearing shells or bushes in a next process step and finally machining the sliding bearing shells or bushes, whereby a final dimension of the sliding layer thickness of 0.005 to 0.1 mm is achieved.

### LIST OF REFERENCE SIGNS

10 Steel back
12 Substrate layer
14 Sliding layer
16 Sliding surface
hG Thickness of the sliding layer
hs Thickness of the substrate layer

1. A sliding bearing element comprising
a steel supporting layer,
a 2-layer composite applied to the supporting layer comprising
a lead-free aluminum-based substrate layer having a layer thickness hs of 0.2 to 0.4 mm, and
a lead-free aluminum-based sliding layer having a layer thickness hG of 0.005 to 0.1 mm,
and wherein the substrate layer and the sliding layer are joined by roll bonding.

2. The sliding bearing element according to claim 1, wherein the substrate layer comprises a first aluminum alloy which, in addition to unavoidable impurities, comprises one or a plurality of the following components
0.1-8.0 wt. % copper,
0.1-2.0 wt. % manganese,
0.2-5 wt. % nickel,
1.0-8.0 wt. % zinc,
0.1-5.0 wt. % magnesium,
0.1-2.0 wt. % silicon,
0.05-1.0 wt. % chromium,
0.05-1.0 wt. % vanadium,
and the rest aluminum.

3. The sliding bearing element according to claim 2, wherein the first aluminum alloy in combination has
0.4-6.0 wt. % copper,
0.3-2.0 wt. % manganese.

4. The sliding bearing element according to claim 3, wherein the first aluminum alloy further has
0.5-3 wt. % nickel and
0.05-1.0 wt. % vanadium.

5. The sliding bearing element according to claim 3, wherein the first aluminum alloy further has
0.2-2.5 wt. % magnesium and
0.1-2.0 wt. % silicon.

6. The sliding bearing element according claim 1, wherein the sliding layer comprises a second aluminum alloy which, in addition to unavoidable impurities, comprises one or more of the following components
1.0-10.0 wt. % silicon,
5.0-30.0 wt. % tin,
0.1-5.0 wt. % copper,
0.1-3.0 wt. % manganese,
0.05-1.0 wt. % vanadium,
0.05-1.0 wt. % chromium, and the rest aluminum.

7. The sliding bearing element according to claim 6, wherein the second aluminum alloy in combination has
1.0-6.0 wt. % silicon,
5.0-25.0 wt. % tin and
0.3-2.5 wt. % copper.

8. The sliding bearing element according to claim 7, wherein the second aluminum alloy further has
0.1-1.5 wt. % manganese.

9. The sliding bearing element according to claim 7, wherein the second aluminum alloy further has
0.05-1.0 wt. % vanadium and
0.05-1.0 wt. % chromium.

10. The sliding bearing element according to claim 1, wherein the substrate layer has a Brinell hardness of 50-100 HBW 1/5/30.

11. The sliding bearing element according to claim 1, wherein the substrate layer has tensile strength of 200-300 MPa.

12. The sliding bearing element according to claim 1, wherein the sliding layer has a Brinell hardness of 25-60 HBW 1/5/30.

13. The sliding bearing element according to claim 1, wherein the sliding layer has a tensile strength of 100-200 MPa.

14. The sliding bearing element according to claim 1, wherein the sliding bearing element is formed as sliding bearing shell.

15. The sliding bearing element according to claim 14, wherein the sliding bearing shell has a nominal diameter of <100 mm.

16. A sliding bearing composed of two sliding bearing shells, of which at least one sliding bearing shell is formed according to claim 15.
